(19) United States
(12) Patent Application Publication
(10) Pub. No.: US 2019/0271445 A1
(43) Pub. Date: Sep. 5, 2019

(54) SYSTEM AND METHOD FOR PRODUCING INDICATOR LIGHT ASSEMBLY WITH PLASTIC HOUSING

(71) Applicant: Dell Products L.P., Round Rock, TX (US)

(72) Inventors: Sheng-Yao Hu, New Taipei City (TW); Kang-Ming Chuang, Kaohsiung City (TW)

(21) Appl. No.: 15/909,414

(22) Filed: Mar. 1, 2018

(51) Int. Cl. F21K 9/90; B23K 26/384; F21K 9/237; F21V 19/00

(52) U.S. Cl. CPC F21K 9/90; B23K 26/384; F21Y 2115/10; F21V 19/003; F21K 9/237

(57) ABSTRACT

A method for producing an indicator light assembly may include selecting a laser power amount based on the thickness of a plastic housing, and drilling multiple conically shaped cutouts in the plastic housing, each creating a respective inner hole with a first diameter and a respective outer hole with a second diameter, the first diameter being larger than the second diameter. The method may include mounting a light source within the plastic housing, positioning the light source near the first holes on the interior side of the plastic housing such that when the light source is enabled, a portion of the emitted light passes through each cutout and is emitted through the second holes on the exterior side of the plastic housing. The second diameter may be small enough that the second holes are not visible to the human eye when the light source is disabled.

### BACKGROUND

### Field of the Disclosure

This disclosure relates generally to information handling systems and, more particularly, to producing indicator light assemblies with plastic housings.

### Description of the Related Art

As the value and use of information continues to increase, individuals and businesses seek additional ways to process and store information. One option available to users is information handling systems. An information handling system generally processes, compiles, stores, and communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Examples of information handling systems include portable devices such as laptop computers, notebook computers, media players, personal data assistants, digital cameras, cellular phones, cordless phones, smart phones, tablet computers, and 2-in-1 tablet-laptop combination computers. A portable device may generally be any device that a user may carry for handheld use and that includes a processor. Typically, portable devices are powered using a rechargeable battery and include a display device. Some portable information handling systems include detachable components, such as keyboards, or are themselves detachable from other components, such as docking stations.

### SUMMARY

In one aspect, a disclosed method for producing an indicator light assembly may include drilling, using a laser, a plurality of conically shaped cutouts in a portion of a plastic housing, each cutout creating a respective first hole with a first diameter on an interior side of the portion of the plastic housing and a respective second hole with a second diameter on an exterior side of the portion of the plastic housing, the first diameter being larger than the second diameter. The method may also include mounting a light source within the plastic housing, the light source being positioned proximate the first holes of the plurality of conically shaped cutouts on the interior side of the portion of the plastic housing such that when the light source is enabled, a portion of the light emitted from the light source passes through each of the conically shaped cutouts and is emitted through the respective second holes of the conically shaped cutouts on the exterior side of the portion of the plastic housing.

In any of the disclosed embodiments, drilling the plurality of conically shaped cutouts may include selecting an optical power output amount for the laser when drilling the plurality of conically shaped cutouts, the selecting being dependent on a thickness of the portion of the plastic housing.

In any of the disclosed embodiments, drilling the plurality of conically shaped cutouts may include selecting an optical power output amount for the laser when drilling the plurality of conically shaped cutouts, the selecting being dependent on at least one of a minimum second diameter for the respective second holes, a maximum second diameter for the respective second holes, a selected second diameter for the respective second holes, a minimum pitch of the plurality of conically shaped cutouts, a maximum pitch of the plurality of conically shaped cutouts, and a selected pitch of the plurality of conically shaped cutouts.

In any of the disclosed embodiments, drilling the plurality of conically shaped cutouts may include drilling each of the plurality of conically shaped cutouts at a respective position within a predetermined two-dimensional pattern for the plurality of cutouts, the predetermined pattern representing a shape of an indicator light to be visible to an observer due to the portion of the light collectively emitted through the respective second holes of the conically shaped cutouts on the exterior side of the portion of the plastic housing when the light source is enabled.

In any of the disclosed embodiments, the number of conically shaped cutouts drilled in the portion of the plastic housing may be dependent on at least one of a type of the light source, a brightness of the light source, a position of the light source, and a distance between the light source and the respective second holes of the conically shaped cutouts on the exterior side of the portion of the plastic housing.

In any of the disclosed embodiments, the method may further include selecting the second diameter for the respective second holes, the selecting including determining a diameter at which the respective second holes of the conically shaped cutouts on the exterior side of the portion of the plastic housing are not visible to the human eye when the light source is disabled.

In any of the disclosed embodiments, the method may further include selecting the second diameter for the respective second holes dependent on at least one of a thickness of the portion of the plastic housing, a selected pitch of the plurality of conically shaped cutouts, and a selected optical power output amount for the laser.

In any of the disclosed embodiments, the method may further include selecting a pitch of the plurality of conically shaped cutouts dependent on at least one of a thickness of the portion of the plastic housing, a selected second diameter for the respective second holes, and a selected optical power output amount for the laser, the selected pitch representing a spacing between two adjacent ones of the plurality of conically shaped cutouts.

In another aspect, a disclosed indicator light assembly may include a plastic housing including a plurality of conically shaped cutouts made in a portion of the plastic housing by a laser, each cutout creating a respective first hole with a first diameter on an interior side of the portion of the plastic housing and a respective second hole with a second diameter on an exterior side of the portion of the plastic housing, the first diameter being larger than the second diameter. The indicator light assembly may further include a light source mounted within the plastic housing, the light source being positioned proximate the respective first holes of the plurality of conically shaped cutouts on the interior side of the portion of the plastic housing such that when the light source is enabled, a portion of the light emitted from the light source passes through each of the conically shaped cutouts and is emitted through the respective second holes of the conically shaped cutouts on the exterior side of the portion of the plastic housing.

In any of the disclosed embodiments, each of the plurality of conically shaped cutouts may be located at a respective position within a predetermined two-dimensional pattern for the plurality of cutouts, the predetermined pattern representing a shape of an indicator light visible to an observer due to the portion of the light collectively emitted through the respective second holes of the conically shaped cutouts on the exterior side of the portion of the plastic housing when the light source is enabled.

In any of the disclosed embodiments, the number of conically shaped cutouts in the portion of the plastic housing may be dependent on at least one of a type of the light source, a brightness of the light source, a position of the light source, and a distance between the light source and the respective second holes of the conically shaped cutouts on the exterior side of the portion of the plastic housing.

In any of the disclosed embodiments, the second diameter for the respective second holes may be a diameter at which the respective second holes of the conically shaped cutouts on the exterior side of the portion of the plastic housing are not visible to the human eye when the light source is disabled.

In any of the disclosed embodiments, the second diameter for the respective second holes may be dependent on at least one of a thickness of the portion of the plastic housing, a selected pitch of the plurality of conically shaped cutouts, and a selected optical power output amount for the laser.

In any of the disclosed embodiments, a pitch of the plurality of conically shaped cutouts may be dependent on at least one of a thickness of the portion of the plastic housing, a selected second diameter for the respective second holes, and a selected optical power output amount for the laser, the pitch representing a spacing between two adjacent ones of the plurality of conically shaped cutouts.

In any of the disclosed embodiments, the light source may include a light-emitting diode.

In yet another aspect, a disclosed information handling system may include a plastic housing including a plurality of conically shaped cutouts made in a portion of the plastic housing by a laser, each cutout creating a respective first hole with a first diameter on an interior side of the portion of the plastic housing and a respective second hole with a second diameter on an exterior side of the portion of the plastic housing, the first diameter being larger than the second diameter. The information handling system may also include a light source mounted within the plastic housing, the light source being positioned proximate the respective first holes of the plurality of conically shaped cutouts on the interior side of the portion of the plastic housing such that when the light source is enabled, a portion of the light emitted from the light source passes through each of the conically shaped cutouts and is emitted through the respective second holes of the conically shaped cutouts on the exterior side of the portion of the plastic housing.

In any of the disclosed embodiments, each of the plurality of conically shaped cutouts may be located at a respective position within a predetermined two-dimensional pattern for the plurality of cutouts, the predetermined pattern representing a shape of an indicator light visible to a user of the information handling system due to the portion of the light collectively emitted through the respective second holes of the conically shaped cutouts on the exterior side of the portion of the plastic housing when the light source is enabled.

In any of the disclosed embodiments, the number of conically shaped cutouts in the portion of the plastic housing may be dependent on at least one of a type of the light source, a brightness of the light source, a position of the light source, and a distance between the light source and the respective second holes of the conically shaped cutouts on the exterior side of the portion of the plastic housing.

In any of the disclosed embodiments, the second diameter for the respective second holes may be a diameter at which the respective second holes of the conically shaped cutouts on the exterior side of the portion of the plastic housing are not visible to the human eye when the light source is disabled.

In any of the disclosed embodiments, the second diameter for the respective second holes may be dependent on at least one of a thickness of the portion of the plastic housing, a selected pitch of the plurality of conically shaped cutouts, and a selected optical power output amount for the laser. A pitch of the plurality of conically shaped cutouts may be dependent on at least one of a thickness of the portion of the plastic housing, a selected second diameter for the respective second holes, and a selected optical power output amount for the laser, the pitch representing a spacing between two adjacent ones of the plurality of conically shaped cutouts.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an information handling system;

FIG. 2 illustrates an example embodiment of a portable information handling system that includes two indicator light assemblies;

FIG. 3 is a cross sectional view illustrating how cutouts are drilled in a plastic housing to create an indicator light assembly, according to at least some embodiments;

FIG. 4 is a cross sectional view illustrating selected elements of an example embodiment of an indicator light assembly;

FIGS. 5A-5C illustrate examples of patterns made by drilling conical cutouts into a plastic housing to create an indicator light;

FIGS. 6A and 6B illustrate two views of an indicator light created using the techniques described herein;

FIG. 7 illustrates selected elements of an example embodiment of an indicator light assembly; and

FIG. 8 is a flow diagram illustrating selected elements of an embodiment of a method 800 for producing an indicator light assembly.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and flash memory, such as a solid-state drive (SSD) comprising solid-state flash memory; as well as communications media such wires, optical fibers, microwaves, radio waves, and other electromagnetic or optical carriers; or any combination of the foregoing.

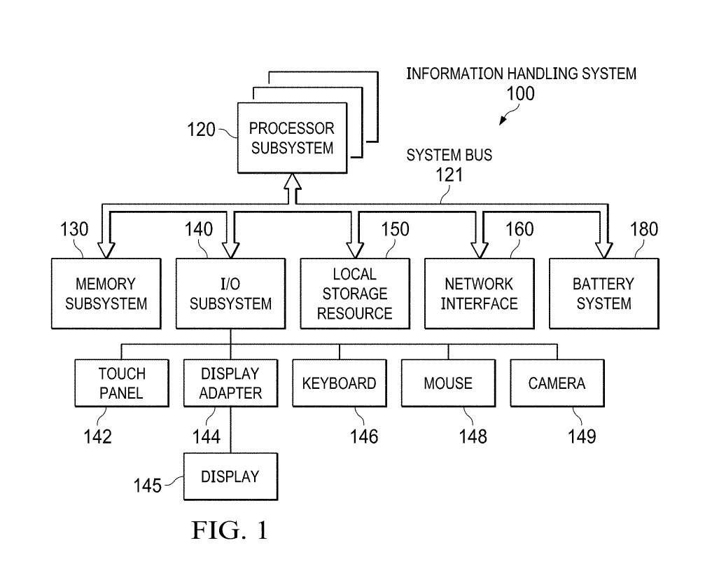

Particular embodiments are best understood by reference to FIGS. 1-4, 5A-5C, 6A-6B, 7, and 8 wherein like numbers are used to indicate like and corresponding parts.

Turning now to the drawings, FIG. 1 illustrates a block diagram depicting selected elements of an embodiment of an information handling system 100. In various embodiments, information handling system 100 may represent different types of portable devices.

As shown in FIG. 1, components of information handling system 100 may include, but are not limited to, processor subsystem 120, which may comprise one or more processors, and system bus 121 that communicatively couples various system components to processor subsystem 120 including, for example, a memory subsystem 130, an I/O subsystem 140, local storage resource 150, a network interface 160, and battery system 180. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus. Battery system 180 may represent a rechargeable battery and related components included with information handling system 100.

In FIG. 1, network interface 160 may be a suitable system, apparatus, or device operable to serve as an interface between information handling system 100 and a network (not shown). Network interface 160 may enable information handling system 100 to communicate over the network using a suitable transmission protocol or standard. In some embodiments, network interface 160 may be communicatively coupled via the network to a network storage resource (not shown). The network coupled to network interface 160 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and messages (generally referred to as data). The network coupled to network interface 160 may transmit data using a desired storage or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), or any combination thereof. The network coupled to network interface 160 or various components associated therewith may be implemented using hardware, software, or any combination thereof.

As depicted in FIG. 1, processor subsystem 120 may comprise a system, device, or apparatus operable to interpret and execute program instructions and process data, and may include a microprocessor, microcontroller, digital signal processor (DSP), application specific integrated circuit (ASIC), or other digital or analog circuitry configured to interpret and execute program instructions and process data. In some embodiments, processor subsystem 120 may interpret and execute program instructions and process data stored locally (e.g., in memory subsystem 130). In the same or alternative embodiments, processor subsystem 120 may interpret and execute program instructions and process data stored remotely (e.g., in a network storage resource).

Also in FIG. 1, memory subsystem 130 may comprise a system, device, or apparatus operable to retain and retrieve program instructions and data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage or a suitable selection or array of volatile or non-volatile memory that retains data after power is removed. Local storage resource 150 may comprise computer-readable media (e.g., hard disk drive, floppy disk drive, CD-ROM, and other type of rotating storage media, flash memory, EEPROM, or another type of solid-state storage media) and may be generally operable to store instructions and data.

In information handling system 100, I/O subsystem 140 may comprise a system, device, or apparatus generally operable to receive and transmit data to, from or within information handling system 100. I/O subsystem 140 may represent, for example, a variety of communication interfaces, graphics interfaces, video interfaces, user input interfaces, and peripheral interfaces. As shown, I/O subsystem 140 may comprise touch panel 142, display adapter 144, keyboard 146, touch pad 148, and camera 149. In other embodiments, I/O subsystem 140 may include more, fewer, or different input/output devices or components. Touch panel 142 may include circuitry for enabling touch functionality in conjunction with a display device, shown as display 145, that is driven by display adapter 144. Camera 149 may represent any of a variety of imaging devices, such as a video camera, infrared camera, or combinations thereof. In some embodiments, camera 149 may be a Webcam.

In various embodiments of information handling system 100, such as portable devices or so-called all-in-one devices, display 145 may be mechanically integrated with other components. Furthermore, touch panel 142 may be integrated into display 145 such that a touch user interface is provided to a user. The touch user interface typically coincides with a pixel space of display 145 such that touch inputs correspond to certain display pixels, which may present user interface elements, such as buttons, menus, input fields, etc., to the user.

In some embodiments, one or more of the devices or components shown within I/O subsystem 140 may be detachable from information handling system 100. For example, in embodiments in which information handling system 100 is a portable information handling system, such as a laptop computer or a tablet computing device, keyboard 146 may be detachable from the information handling system. In some embodiments in which information handling system 100 is a portable information handling system, the information handling system may be detachable from a docking station or base.

Information handling systems, such as handling system 100, may include one or more indicator lights for various purposes (not shown). In existing systems, these indicator lights may be constructed as indicator light assemblies in which light-emitting diodes (LEDs) are visible through holes made in the chassis. For example, a hole for a light-emitting diode is typically made in a plastic housing during the injection molding process using a metal pin structure or other tooling to define the hole. The precision of the injection molding process is currently such that the smallest hole that can be made is one with a diameter on the order of 0.9 to 1.0 mm. Using this process, in order to include an indicator light in an information handling system or other electronic device with a plastic housing, it may be necessary to have a large, visible hole in the plastic and to cover the hole with a transparent material to let the light penetrate through. For example, in existing systems, an indicator light assembly that includes an LED (e.g., a Webcam indication light or a power indicator light) typically includes a transparent light guide material (e.g., a transparent polycarbonate sheet) between the LED and the chassis, and a visible hole in the plastic housing for the LED with a diameter of approximately 0.95 mm.

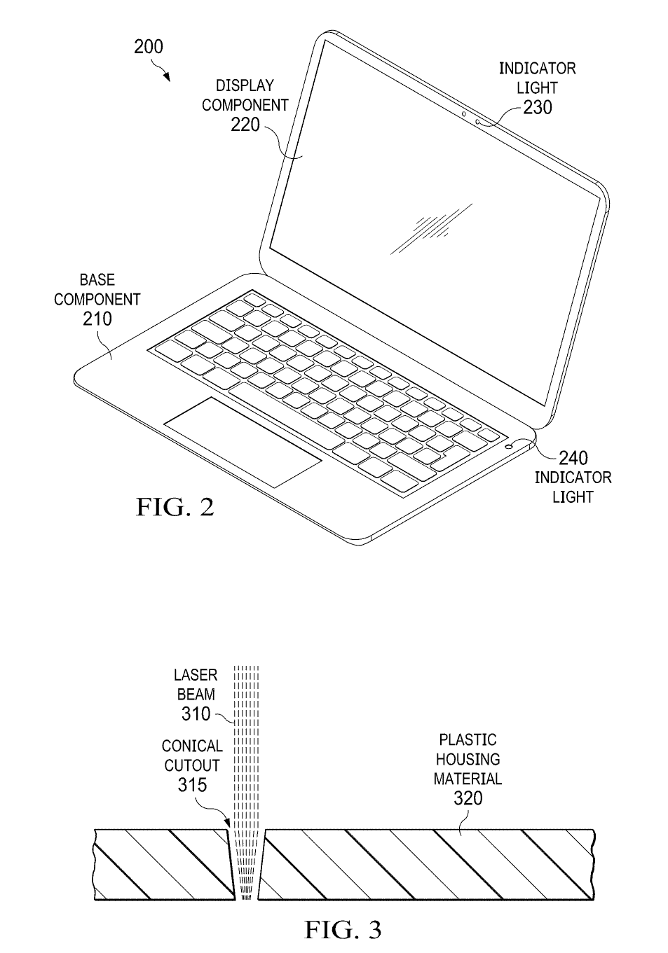

In some embodiments of the present disclosure, a laser drilling process may be used to create an indicator light assembly that does not require a light guide and that does not produce a large, visible hole in the plastic housing of the information handling system or other electronic device in which it is installed. Instead, this process may be used to create an indicator light with a laser induced geometry including multiple very small holes on the exterior of the plastic housing that are not visibly discernable to the human eye when not back-lit by a light source. For example, in some embodiments, a laser cutting machine with a precision of 20 to 80 um may be used to drill conically shaped cutouts in the plastic housing, creating holes on the exterior side of the plastic housing with diameters of 0.1 mm, 0.09 mm, or less in a plastic housing with a thickness of between 1.0 and 1.2 mm. As described in more detail below, in embodiments in which an indicator light assembly is produced using this technique, light emitted by a light source within the plastic housing can penetrate through these tiny holes in the plastic, but the holes themselves may not be visually discernable when the indication light is off. Examples of such indicator light assemblies, or portions thereof, are illustrated in FIGS. 2, 3, 4, 5A-5C, 6A-6B, and 7, and described in more detail below.

FIG. 2 illustrates an example embodiment of a portable information handling system 200 that includes two indicator light assemblies produced as described herein. In the illustrated embodiment, portable information handling system 200 includes a base component 210 and a display component 220. The display component 220 includes a first indicator light 230 (e.g., a Webcam indicator light that, when illuminated, indicates that a built-in Webcam is active). The base component 210 includes a second indicator light 240 (e.g., power indicator light that, when illuminated, indicates that portable information handling system 200 is powered on).

FIG. 3 is a cross sectional view illustrating how cutouts are drilled in a plastic housing to create an indicator light assembly, according to at least some embodiments. For example, FIG. 3 illustrates a laser beam 310 drilling a conical cutout 315 in plastic housing material 320. Laser beam 310 may be generated by a high precision laser cutting machine designed for micro drilling. In certain embodiments, laser beam 310 may be generated by a laser cutting machine that employs a fusion drilling process with pulsed lasers and external gas support, or by a laser cutting machine that employs a laser-induced vaporization and melt ejection process, for example. The wavelength and power density of laser beam 310 may be selected based on the characteristics of plastic housing material 320 and its thickness.

As shown in this example, the conical cutout 315 creates a passage all the way through plastic housing material 320. More specifically, conical cutout 315 creates, on one of plastic housing material 320 (in this case, the top side), a first hole having a first diameter and creates, on the other side of plastic housing material 320 (in this case, the bottom side), a second hole having a second diameter that is smaller than the first diameter. The shape of the cutout serves to direct and focus the light emitted by a light source and gathered at the first hole on the top side of the cutout toward the second hole on the bottom side of the cutout, from which the light will be emitted.

In various embodiments, the plastic housing material may be any of a variety of plastics suitable for the chassis housings of information handling systems and other electronic devices including, but not limited to, polycarbonates, acrylonitrile butadiene styrene, polycarbonates plus acrylonitrile butadiene styrene, and polyamide nylon.

In order to drill the conically shaped cutouts in the plastic housing material, a specific optical power output amount may be selected for the laser. In some embodiments, the selection of the laser power may be dependent on the thickness of the plastic housing material to be drilled. In some embodiments, the selection of the laser power may be dependent on a minimum, maximum, or desired diameter for the holes on the exterior side of the plastic housing, or a minimum, maximum, or desired pitch of the conically shaped cutouts. In some embodiments, if the laser power is not properly tuned, or if the size and/or pitch of the holes are not appropriate for the type and/or thickness of the plastic housing material, the plastic housing material may melt and/or the laser may produce holes on the exterior of the plastic housing that are visible.

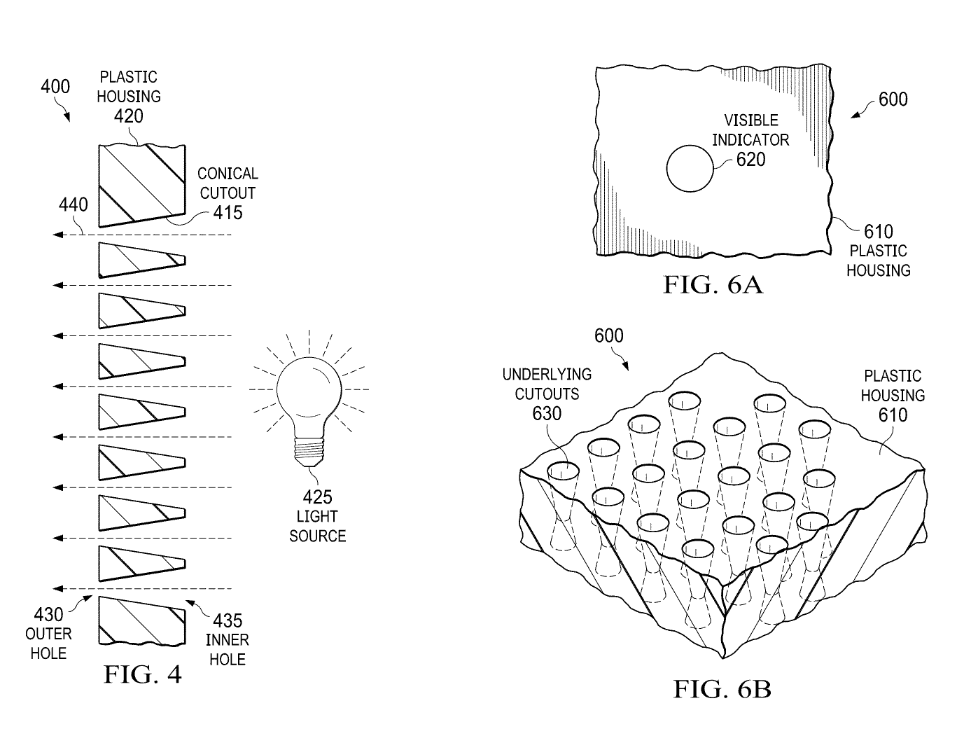

FIG. 4 is a cross sectional view illustrating selected elements of an example embodiment of an indicator light assembly 400. In the illustrated embodiment, indicator light assembly 400 includes plastic housing 420, into which multiple conical cutouts 415 have been drilled using a laser, and light source 425. As illustrated in FIG. 4, the drilling of each conical cutout 415 has created a first hole on the interior side of plastic housing 420 (e.g., inner hole 435) and a second hole on the exterior side of plastic housing 420 (e.g., outer hole 430). The diameter of the inner holes 435 is larger than the diameter of the outer holes 430. In one example embodiment in which the plastic housing 420 has a thickness of 1.2 mm, the diameter of the inner holes 435 may be approximately 0.15 mm, while the diameter of the outer holes 430 may be 0.1 mm or less.

In the illustrated example, light source 425 is enabled, i.e., it is powered and is emitting light. Arrows 440 represent portions of the light emitted by light source 425 that pass through each of the conical cutouts drilling in plastic housing 420 and are emitted from the outer holes 430. The shape of the emitted light, as discerned by an observer, depends on the number and arrangement of conical cutouts 415 and corresponding outer holes 430.

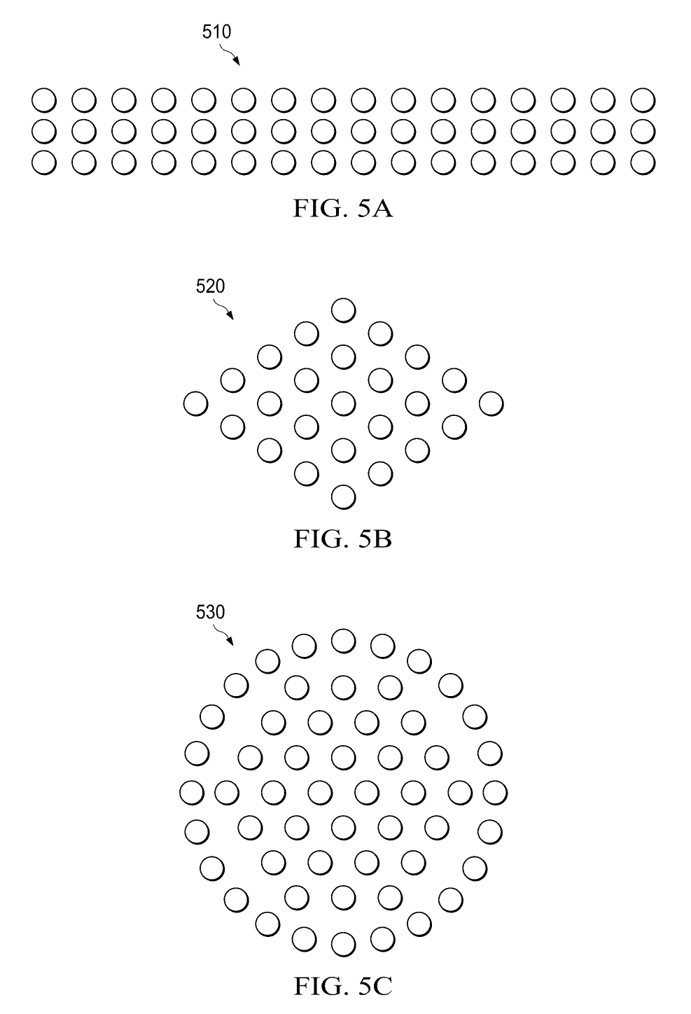

FIGS. 5A-5C illustrate examples of patterns made by drilling conical cutouts into a plastic housing to create an indicator light that is visible on the exterior side of the plastic housing when a light source on the interior side of the plastic housing is enabled. In each of these examples, the conical cutouts may be sized and spaced so that the outer holes through which light is emitted when the light source is enabled are not visibly discernable to the human eye when the light source is disabled, i.e., when the light source is not powered and is not emitting light. When the light source is enabled, the light that is emitted by the outer holes may, collectively, appear as a single indicator light having a particular shape and size (area). The number of conically shaped cutouts drilled in the plastic housing to produce a desired indicator light may be dependent the type of the light source, the brightness of the light source, the position of the light source, and/or the distance between the light source and the holes on the exterior side of the plastic housing, as well as the total area to be covered by the indicator light formed (collectively) by the outer holes.

In one example, FIG. 5A illustrates a rectangular pattern 510 of outer holes drilled in a plastic housing, including three rows of sixteen outer holes. In this example, the pitch (i.e., the spacing between adjacent outer holes in one or more directions) may be on the order of 0.3 mm, which may be approximately three times the diameter of each outer hole. When the light source is enabled, the light that is emitted by the outer holes illustrated in FIG. 5A may, collectively, appear as if it were being emitted by a single rectangular indicator light.

FIG. 5B illustrates a second pattern 520 of outer holes drilled in a plastic housing, as described herein. In this example, the plastic housing may be thicker than the plastic housing in the example shown in FIG. 5A. In this example, the pitch may be larger than the pitch shown in FIG. 5A. When the light source is enabled, the light that is emitted by the outer holes illustrated in FIG. 5B may, collectively, appear as if it were being emitted by a single diamond shaped indicator light.

FIG. 5C illustrates a third pattern 530 of outer holes drilled in a plastic housing, as described herein. In this example, the plastic housing may be thinner than the plastic housing in the example shown in FIG. 5A. In this example, the pitch may be smaller than the pitch shown in FIG. 5A. When the light source is enabled, the light that is emitted by the outer holes illustrated in FIG. 5C may, collectively, appear as if it were being emitted by a single circular indicator light.

The patterns of outer holes illustrated in FIGS. 5A-5C are merely examples. In other embodiments, the conical cutouts drilled in a plastic housing to create an indicator light assembly, and the corresponding outer holes, may be arranged in any standard or custom pattern suitable for the application.

FIGS. 6A and 6B illustrate two views of an indicator light 600 created using the techniques described herein. Specifically, FIG. 6A illustrates a view of a portion of a plastic housing 610 from the perspective of an observer looking at the exterior side of plastic housing 610. The illustrated portion of plastic housing 610 includes a visible indicator 620 that appears as if it were a single circular indicator light. FIG. 6B is a perspective view of a cross section of plastic housing 610 illustrating a portion of an underlying pattern of conically shaped cutouts 630 through which light is emitted to create the indicator light shown in FIG. 6A when a light source on the interior side of plastic housing 610 is enabled. Note that when the light source is disabled, the portion of plastic housing 610 into which the pattern of conically shaped cutouts 630 has been drilled may appear to the human eye as if it were a solid plastic housing.

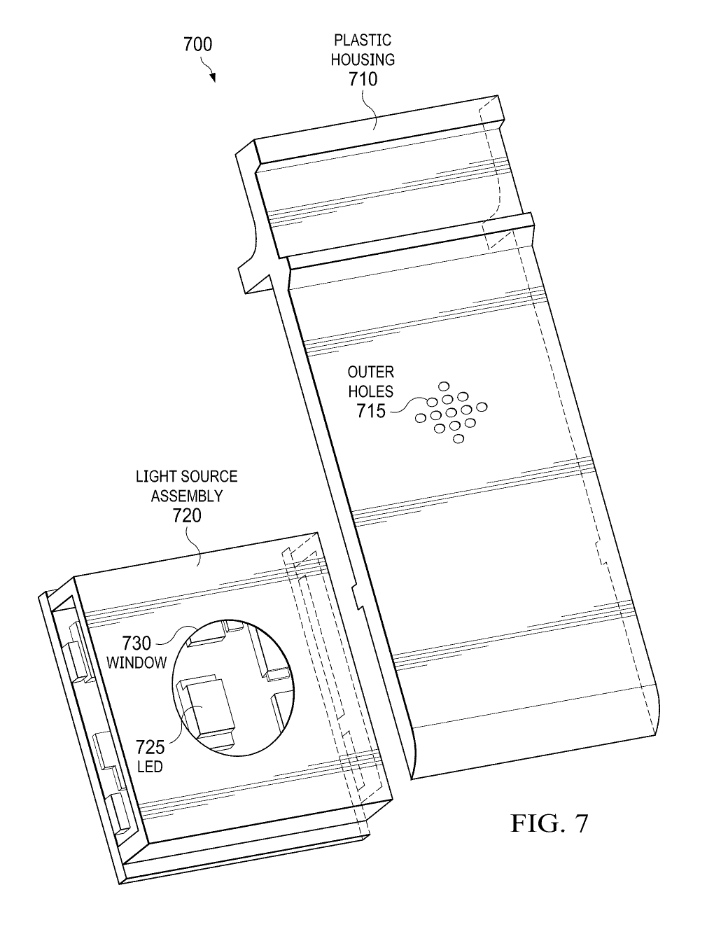

FIG. 7 illustrates selected elements of an example embodiment of an indicator light assembly 700. In this example, indictor light assembly 700 includes a plastic housing 710, which may represent a portion of a chassis for an information handling system or another type of electronic device. Plastic housing 710 is shown having a plurality of outer holes 715 each created by drilling a respective conically shaped cutout in plastic housing 710 by a laser. In this example, the outer holes 715 are arranged in a diamond shaped pattern.

Indicator light assembly 700 also includes a light source assembly 720, including an opening (shown as window 730) through which light from a light-emitting diode (shown as LED 725) is emitted. In this example, once light source assembly 720 is mounted behind plastic housing 710 such that window 730 is positioned behind the conically shaped cutouts in plastic housing 710 corresponding to outer holes 715, any light emitted by LED 725 may pass through the conically shaped cutouts and be emitted by outer holes 715. In this example, when light is emitted by the plurality of outer holes 715, it may appear to the human eye as if it is being emitted by a single diamond shaped indicator light. On the other hand, outer holes 715 may be too small to be visibly discernable to the human eye when no light is being emitted by LED 725.

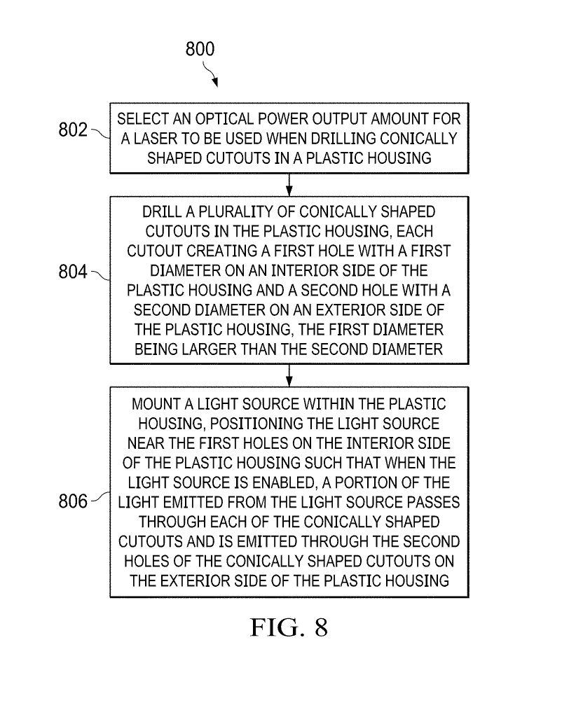

FIG. 8 is a flow diagram illustrating selected elements of an embodiment of a method 800 for producing an indicator light assembly, as described herein. It is noted that certain operations described in method 800 may be optional or may be performed in a different order than the order illustrated in FIG. 8, in different embodiments. Method 800 may begin, at 802, by selecting an optical power output amount for a laser to be used when drilling conically shaped cutouts in a plastic housing. In various embodiments, the plastic housing may be made of any of a variety of plastics suitable for the chassis housings of information handling systems and other electronic devices including, but not limited to, polycarbonates, acrylonitrile butadiene styrene, polycarbonates plus acrylonitrile butadiene styrene, and polyamide nylon. In some embodiments, selecting an optical power output amount for the laser may be dependent on the thickness of the plastic housing, a minimum, maximum, or desired diameter for the holes to be created on an interior side of the plastic housing, and/or a minimum, maximum, or desired pitch of the conically shaped cutouts.

At 804, the method may include drilling a plurality of conically shaped cutouts in the plastic housing, each cutout creating a first hole with a first diameter on the interior side of the plastic housing and a second hole with a second diameter on an exterior side of the plastic housing, the first diameter being larger than the second diameter. In some embodiments, the drilling operation may include selecting the second diameter for the second holes, which may include determining a diameter at which the second holes are not visible to the human eye when not back-lit by the light source. In some embodiments, the drilling operation may include selecting the second diameter for the second holes dependent on the thickness of the plastic housing, a selected pitch of the conically shaped cutouts, and/or a selected optical power output amount for the laser. In some embodiments, the drilling operation may include selecting a pitch of the conically shaped cutouts dependent on the thickness of the plastic housing, a selected second diameter for the second holes, and/or a selected optical power output amount for the laser. The selected pitch may represent a spacing between two adjacent ones of the conically shaped cutouts.

In some embodiments, drilling the conically shaped cutouts may include drilling each of the conically shaped cutouts at a respective position within a predetermined two-dimensional pattern for the cutouts. The predetermined pattern may represent the shape of an indicator to be visible to an observer due to the light collectively emitted through the respective second holes of the conically shaped cutouts on the exterior side of the plastic housing when back-lit by the light source. The number of conically shaped cutouts drilled in the plastic housing may be dependent on the type of the light source, the brightness of the light source, the position of the light source, and/or the distance between the light source and the respective second holes of the conically shaped cutouts on the exterior side of the plastic housing.

At 806, the method may include mounting a light source within the plastic housing. The light source may be positioned near the first holes on the interior side of the plastic housing such that when the light source is enabled, a portion of the light emitted from the light source passes through each of the conically shaped cutouts and is emitted through the second holes of the conically shaped cutouts on the exterior side of the plastic housing. In some embodiments the light source may be a light-emitting diode, or may be a light source assembly that includes a light-emitting diode and a window through which light from the light-emitting diode is emitted.

While FIG. 8 illustrates one example method for producing an indicator light assembly using a described technique for machining a plastic housing of an information handling system or other electronic device, the techniques described herein may be implemented by components that are manufactured and/or assembled using other techniques, in certain embodiments. While indicator light assemblies and housings are described as being made from particular materials, they may be manufactured using different materials or combinations of materials, in certain embodiments. In addition, while methods for producing an indicator light assembly are described primarily in terms of their applicability in information handling systems, the disclosed techniques may be applied to produce indicator light assemblies for other applications, in certain embodiments.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for producing an indicator light assembly, comprising:
drilling, using a laser, a plurality of conically shaped cutouts in a portion of a plastic housing, each cutout creating a respective first hole with a first diameter on an interior side of the portion of the plastic housing and a respective second hole with a second diameter on an exterior side of the portion of the plastic housing, the first diameter being larger than the second diameter;
mounting a light source within the plastic housing, the light source being positioned proximate the first holes of the plurality of conically shaped cutouts on the interior side of the portion of the plastic housing such that when the light source is enabled, a portion of the light emitted from the light source passes through each of the conically shaped cutouts and is emitted through the respective second holes of the conically shaped cutouts on the exterior side of the portion of the plastic housing.

2. The method of claim 1, wherein drilling the plurality of conically shaped cutouts comprises selecting an optical power output amount for the laser when drilling the plurality of conically shaped cutouts, the selecting being dependent on a thickness of the portion of the plastic housing.

3. The method of claim 1, wherein drilling the plurality of conically shaped cutouts comprises selecting an optical power output amount for the laser when drilling the plurality of conically shaped cutouts, the selecting being dependent on at least one of a minimum second diameter for the respective second holes, a maximum second diameter for the respective second holes, a selected second diameter for the respective second holes, a minimum pitch of the plurality of conically shaped cutouts, a maximum pitch of the plurality of conically shaped cutouts, and a selected pitch of the plurality of conically shaped cutouts.

4. The method of claim 1, wherein drilling the plurality of conically shaped cutouts comprises drilling each of the plurality of conically shaped cutouts at a respective position within a predetermined two-dimensional pattern for the plurality of cutouts, the predetermined pattern representing a shape of an indicator light to be visible to an observer due to the portion of the light collectively emitted through the respective second holes of the conically shaped cutouts on the exterior side of the portion of the plastic housing when the light source is enabled.

5. The method of claim 1, wherein the number of the plurality of conically shaped cutouts drilled in the portion of the plastic housing is dependent on at least one of a type of the light source, a brightness of the light source, a position of the light source, and a distance between the light source and the respective second holes of the conically shaped cutouts on the exterior side of the portion of the plastic housing.

6. The method of claim 1, further comprising:
selecting the second diameter for the respective second holes, the selecting including determining a diameter at which the respective second holes of the conically shaped cutouts on the exterior side of the portion of the plastic housing are not visible to the human eye when the light source is disabled.

7. The method of claim 1, further comprising selecting the second diameter for the respective second holes dependent on at least one of a thickness of the portion of the plastic housing, a selected pitch of the plurality of conically shaped cutouts, and a selected optical power output amount for the laser.

8. The method of claim 1, further comprising selecting a pitch of the plurality of conically shaped cutouts dependent on at least one of a thickness of the portion of the plastic housing, a selected second diameter for the respective second holes, and a selected optical power output amount for the laser, the selected pitch representing a spacing between two adjacent ones of the plurality of conically shaped cutouts.

9. An indicator light assembly, comprising:
a plastic housing comprising a plurality of conically shaped cutouts made in a portion of the plastic housing by a laser, each cutout creating a respective first hole with a first diameter on an interior side of the portion of the plastic housing and a respective second hole with a second diameter on an exterior side of the portion of the plastic housing, the first diameter being larger than the second diameter;
a light source mounted within the plastic housing, the light source being positioned proximate the respective first holes of the plurality of conically shaped cutouts on the interior side of the portion of the plastic housing such that when the light source is enabled, a portion of the light emitted from the light source passes through each of the conically shaped cutouts and is emitted through the respective second holes of the conically shaped cutouts on the exterior side of the portion of the plastic housing.

10. The indicator light assembly of claim 9, wherein each of the plurality of conically shaped cutouts is located at a respective position within a predetermined two-dimensional pattern for the plurality of cutouts, the predetermined pattern representing a shape of an indicator light visible to an observer due to the portion of the light collectively emitted through the respective second holes of the conically shaped cutouts on the exterior side of the portion of the plastic housing when the light source is enabled.

11. The indicator light assembly of claim 9, wherein the number of the plurality of conically shaped cutouts in the portion of the plastic housing is dependent on at least one of a type of the light source, a brightness of the light source, a position of the light source, and a distance between the light source and the respective second holes of the conically shaped cutouts on the exterior side of the portion of the plastic housing.

12. The indicator light assembly of claim 9, wherein the second diameter for the respective second holes is a diameter at which the respective second holes of the conically shaped cutouts on the exterior side of the portion of the plastic housing are not visible to the human eye when the light source is disabled.

13. The indicator light assembly of claim 9, wherein the second diameter for the respective second holes is dependent on at least one of a thickness of the portion of the plastic housing, a selected pitch of the plurality of conically shaped cutouts, and a selected optical power output amount for the laser.

14. The indicator light assembly of claim 9, wherein a pitch of the plurality of conically shaped cutouts is dependent on at least one of a thickness of the portion of the plastic housing, a selected second diameter for the respective second holes, and a selected optical power output amount for the laser, the pitch representing a spacing between two adjacent ones of the plurality of conically shaped cutouts.

15. The indicator light assembly of claim 9, wherein the light source comprises a light-emitting diode.

16. An information handling system, comprising:
a plastic housing comprising a plurality of conically shaped cutouts made in a portion of the plastic housing by a laser, each cutout creating a respective first hole with a first diameter on an interior side of the portion of the plastic housing and a respective second hole with a second diameter on an exterior side of the portion of the plastic housing, the first diameter being larger than the second diameter;
a light source mounted within the plastic housing, the light source being positioned proximate the respective first holes of the plurality of conically shaped cutouts on the interior side of the portion of the plastic housing such that when the light source is enabled, a portion of the light emitted from the light source passes through each of the conically shaped cutouts and is emitted through the respective second holes of the conically shaped cutouts on the exterior side of the portion of the plastic housing.

17. The information handling system of claim 16, wherein each of the plurality of conically shaped cutouts is located at a respective position within a predetermined two-dimensional pattern for the plurality of cutouts, the predetermined pattern representing a shape of an indicator light visible to a user of the information handling system due to the portion of the light collectively emitted through the respective second holes of the conically shaped cutouts on the exterior side of the portion of the plastic housing when the light source is enabled.

18. The information handling system of claim 16, wherein the number of the plurality of conically shaped cutouts in the portion of the plastic housing is dependent on at least one of a type of the light source, a brightness of the light source, a position of the light source, and a distance between the light source and the respective second holes of the conically shaped cutouts on the exterior side of the portion of the plastic housing.

19. The information handling system of claim 16, wherein the second diameter for the respective second holes is a diameter at which the respective second holes of the conically shaped cutouts on the exterior side of the portion of the plastic housing are not visible to the human eye when the light source is disabled.

20. The information handling system of claim 16, wherein:
the second diameter for the respective second holes is dependent on at least one of a thickness of the portion of the plastic housing, a selected pitch of the plurality of conically shaped cutouts, and a selected optical power output amount for the laser; and
a pitch of the plurality of conically shaped cutouts is dependent on at least one of a thickness of the portion of the plastic housing, a selected second diameter for the respective second holes, and a selected optical power output amount for the laser, the pitch representing a spacing between two adjacent ones of the plurality of conically shaped cutouts.
